(19) United States
(12) Patent Application Publication
(10) Pub. No.: US 2015/0249858 A1
(43) Pub. Date: Sep. 3, 2015

(54) IMAGE RECEIVING APPARATUS, MOBILE TERMINAL, SERVER, IMAGE RECEIVING METHOD AND STORING METHOD

(71) Applicant: KABUSHIKI KAISHA TOSHIBA, Tokyo (JP)

(72) Inventors: Tomohiro YAMASAKI, Tokyo (JP); Masaru SUZUKI, Kawasaki Kanagawa (JP)

(73) Assignee: KABUSHIKI KAISHA TOSHIBA, Tokyo (JP)

(21) Appl. No.: 14/713,557

(22) Filed: May 15, 2015

Related U.S. Application Data
(63) Continuation of application No. PCT/JP2012/079753, filed on Nov. 16, 2012.

(51) Int. Cl. H04N 21/433; H04N 21/4405; H04N 21/231; H04N 21/239; H04N 21/258; H04N 21/262; H04N 21/414; H04N 21/4408

(52) U.S. Cl. CPC H04N 21/4334; H04N 21/41407; H04N 21/4405; H04N 21/4408; H04N 21/2396; H04N 21/25875; H04N 21/25816; H04N 21/26258; H04N 21/231

(57) ABSTRACT

According to one embodiment, an image receiving apparatus includes a tuner, a verification unit, a transceiver and a display. The tuner decodes a broadcast wave into a video content. The verification unit performs a verification that determines whether or not a use of the decoded video content falls under a personal use. The transceiver encrypts and transmits the video content to a server when the verification is successful, and transmits to the server an acquisition request and receives the list. The transceiver receives from the user a play request, transmits the play request to the server to receive the first video content which is encrypted, and decrypts the first video content which is encrypted. The display displays the decrypted first video content.

### CROSS-REFERENCE TO RELATED APPLICATIONS

This application is a Continuation Application of PCT Application No. PCT/JP2012/079753, filed Nov. 16, 2012, the entire contents of which are incorporated herein by reference.

### FIELD

Embodiments described herein relate generally to an image receiving apparatus, a mobile terminal, a server, an image receiving method and a storing method.

### BACKGROUND

In recent years, since a variety of media has gained superiority over television, and more choices are available for a user, the way of viewing video content is significantly changing. Specifically, a style of watching a video content has been shifting from watching TV program in real-time to watching recorded materials.

In a television broadcast system, data of the same program is usually sent at the same time to each household. Thus, there may be a case where a program that you did not record was recorded by someone else. To view such a program that you missed watching, there is a method of sharing a recorder program using an Internet video sharing service, etc. Also, since smart phones and tablets are becoming popular, the number of opportunities of viewing a video content individually is increasing.

On the other hand, against the backdrop of increased storage capacity and improvement in video compressing methods, there is a method of recording all programs on all channels.

### BRIEF DESCRIPTION OF THE DRAWINGS

FIG. 1 is a conceptual drawing of a cloud television system according to a first embodiment.

FIG. 2 is a block diagram illustrating an image receiving apparatus according to the first embodiment.

FIG. 3 is a block diagram illustrating a server according to the first embodiment.

FIG. 4 is a drawing indicating a priority of program contents displayed on the image receiving apparatus.

FIG. 5 is a drawing indicating an example of broadcast stations selected in accordance with the priority.

FIG. 6 is a drawing showing an example of a verification process at the image receiving apparatus.

FIG. 7 is a flowchart showing an operation of the cloud television system according to the first embodiment.

FIG. 8 is a flowchart showing a storing process for encrypted content at the server.

FIG. 9 is a flowchart showing an operation of program content management.

FIG. 10 is a drawing showing an example of a display of a list of program contents on the image receiving apparatus.

FIG. 11 is a conceptual drawing of a cloud television system according to a second embodiment.

FIG. 12 is a block diagram illustrating a mobile terminal.

FIG. 13 is a drawing showing an example of a verification process at the mobile terminal.

FIG. 14 is a flowchart showing an operation of the cloud television system according to the second embodiment.

### DETAILED DESCRIPTION

In general, according to one embodiment, an image receiving apparatus includes a tuner, a verification unit, a transceiver and a display. The tuner decodes a broadcast wave into a video content. The verification unit performs a verification that determines whether or not a use of the decoded video content falls under a personal use. The transceiver encrypts and transmits the video content to a server when the verification is successful, and transmits to the server an acquisition request and receives the list when the acquisition request is received from a user, the acquisition request being a request for obtaining a list of a plurality of video contents stored in the server The display displays the list and the video content. The transceiver receives from the user a play request for designating a first video content to play from the video contents included in the list, transmits the play request to the server to receive the first video content which is encrypted, and decrypts the first video content which is encrypted. The display displays the decrypted first video content.

In the following, an image receiving apparatus, a mobile terminal, a server, an image receiving method and a storing method according to the present embodiment will be described in detail with reference to the drawings. In the following embodiments, the elements which perform the same operation will be assigned the same reference symbol, and redundant explanations will be omitted as appropriate.

### First Embodiment

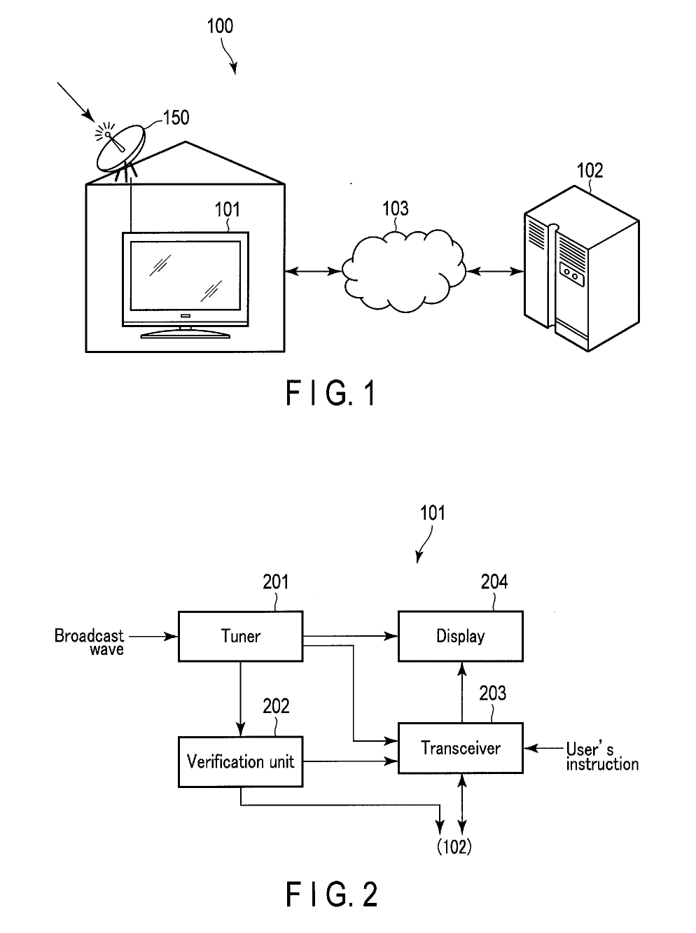

A cloud television (TV) system according to the first embodiment will be described with reference to FIG. 1.

FIG. 1 is a conceptual drawing of a cloud TV system according to the first embodiment. A cloud TV system 100 includes an image receiving apparatus 101, a server 102, and a network 103.

The image receiving apparatus 101 is a TV at a household. The image receiving apparatus 101 decodes and plays a broadcast program transmitted in the form of a broadcast wave that has been broadcast from a broadcast station (not shown in the drawings) and received at an antenna 150. A video content is a TV program of a terrestrial digital broadcast or a satellite broadcast, for example.

Subsequently, the image receiving apparatus 101 carries out verification. If the verification is successful, the video content is encrypted, and the encrypted video content (hereinafter, “the encrypted content”) is transmitted to the server 102 via the network 103. The image receiving apparatus 101 receives the video content from the server 102 via the network 103 in accordance with a user's request, and decrypts and plays the video content.

The server 102 receives the encrypted content via the network 103, and stores the encrypted content. When the server 102 receives from the image receiving apparatus 101 a play request designating the video content that a user wants to play among the stored video contents, the server 102 extracts the designated video content in accordance with the play request, and the server 102 sends the extracted video content to the image receiving apparatus 101 via the network 103.

The network 103 is a general network that enables wired or wireless communication with the image receiving apparatus 101 and the server 102.

Next, the image receiving apparatus according to the first embodiment is described with reference to the block diagram of FIG. 2.

The image receiving apparatus 101 according to the first embodiment includes a tuner 201, a verification unit 202, a transceiver 203 and a display 204.

The tuner 201 receives and decodes a broadcast wave, and obtains the video content. Since the decoding process at the tuner 201 is a common process for decoding broadcast waves, an explanation thereof is omitted.

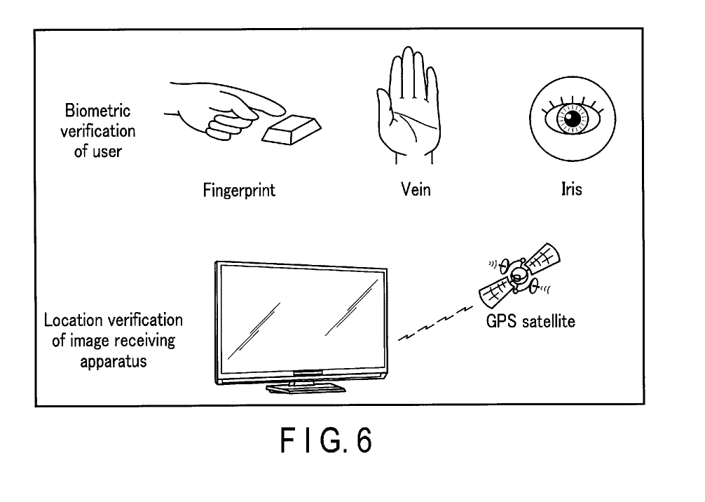

The verification unit 202 receives the video content from the tuner 201, verifies whether or not the decoded video content is for personal household use, and obtains a verification result. The verification unit 202 has an encryption key used for encrypting and decrypting the video content. Information unique for each household may be used as an encryption key. The verification of whether or not the video content is for personal household use is described with reference to FIG. 6.

The transceiver 203 receives the video content from the tuner 201, and a verification result from the verification unit 202. If the verification result indicates a successful verification, the transceiver 203 receives an encryption key from the verification unit 202, encrypts the video content using the encryption key, and transmits the encrypted content to the server 102.

If the transceiver 203 receives from a user a list acquisition request indicating a request of video content list, the transceiver 203 sends the list acquisition request to the server 102, and receives a video content list from the server 102. If the transceiver 203 receives a play request indicating the video content in the video contents list designated by a user, the transceiver 203 transmits the play request to the server 102, receives the designated encrypted content from the server 102, and decrypts the encrypted content using the encryption key.

The display 204 receives and displays the video content from the tuner 201. If the display 204 receives the video content list from the transceiver 203, the display 204 also displays the video content list, and if the display 204 receives the selected video content from the transceiver 203, the display 204 displays the selected video content.

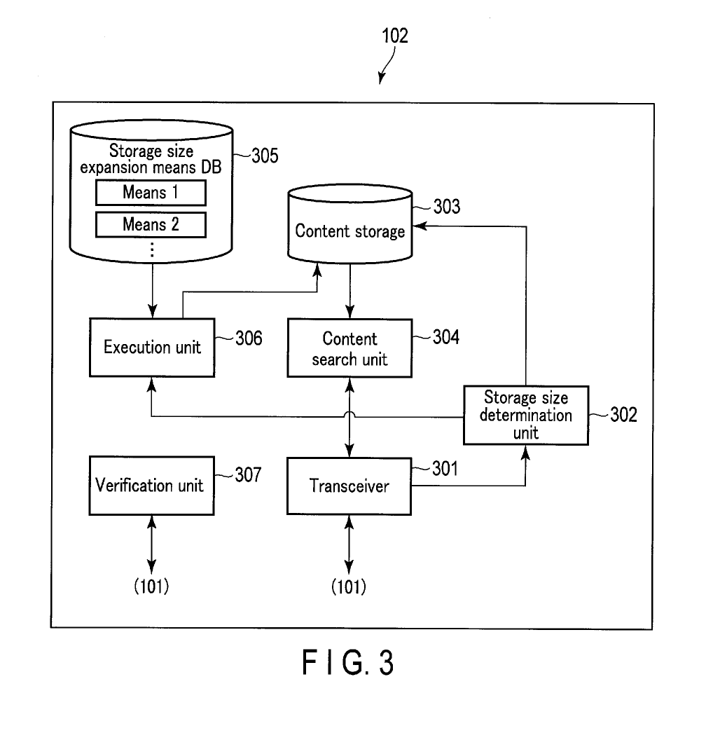

Next, the server according to the first embodiment is described with reference to the block diagram of FIG. 3.

The server 102 according to the first embodiment includes a transceiver 301, a storage size determination unit 302, a content storage 303, a content search unit 304, a storage size expansion means database 305 (hereinafter, “storage size expansion means DB 305”), an execution unit 306, and a verification unit 307.

The transceiver 301 receives an encrypted content from the image receiving apparatus 101. If the transceiver 301 receives a list acquisition request from the image receiving apparatus 101, the transceiver 301 acquires the video content list from the content search unit 304 (will be described later), and transmits it to the image receiving apparatus 101. If the transceiver 301 receives a play request from the image receiving apparatus 101, the transceiver 301 acquires a selected encrypted content from the content search unit 304 and transmits it to the image receiving apparatus 101.

The storage size determination unit 302 receives the encrypted content from the transceiver 301, and determines whether or not there is a space in the content storing unit 303 for storing the encrypted content. If there is no space, in other words, there is no sufficient capacity for storing the video content, the storage size determination unit 302 generates storage space shortage information. The storage space shortage information is information indicating a space in the storage required for storing the video content.

If there is a space for storing the encrypted content, the content storage 303 receives the encrypted content from the storage size determination unit 302, and stores it. In the present embodiment, the process of storing an encrypted content may be referred to as “recording”. The content storage 303 prepares a specific storage area for storing video contents for each household on contract. It is desirable to completely separate a specific storage area for each household on contract so that only the user who has a contract for a specific storage area can access the specific storage area.

The contract for a specific storage area at a household may be concluded when a user buys the image receiving apparatus 101, like a mobile phone contract, or may be concluded at another time, like a contract with an Internet service provider. If the contract is concluded at a time different from the time of purchasing the image receiving apparatus 101, distribution of an encryption key used for content encryption may be complicated. In the present embodiment, the contract for a specific storage area is concluded at the time of purchasing the image receiving apparatus 101, and an encryption key generated for each contracted household is stored in the verification unit 202 of the image receiving apparatus 101.

If the content search unit 304 receives the list acquisition request from the transceiver 301, the content search unit 304 generates a list of video contents stored in the content storage 303. The content search unit 304 searches and acquires the video content corresponding to a play request from a user from the video contents stored in the content storage 303.

When storing a new video content in the content storage 303, if the content storage 303 has a list of stored video contents which is updated, for example, by adding the new video content, the content search unit 304 may extract the list from the content storage 303.

The storage size expansion means DB 305 stores information on what kind of storage size expansion means is used for increasing a storage capacity of the specific storage area in the content storage 303. The storage size expansion means is a process for securing a space for storing the video content; for example, a process of increasing a capacity of the specific storage area by allocating a new space to the specific storage area.

The execution unit 306 receives the storage space shortage information from the storage size determination unit 302, extracts a storage size expansion means from the storage size expansion means DB 305, and executes the storage size expansion means for increasing a capacity of the specific storage area in the content storage 303.

The verification unit 307 receives a verification key from the image receiving apparatus 101, and verifies a user.

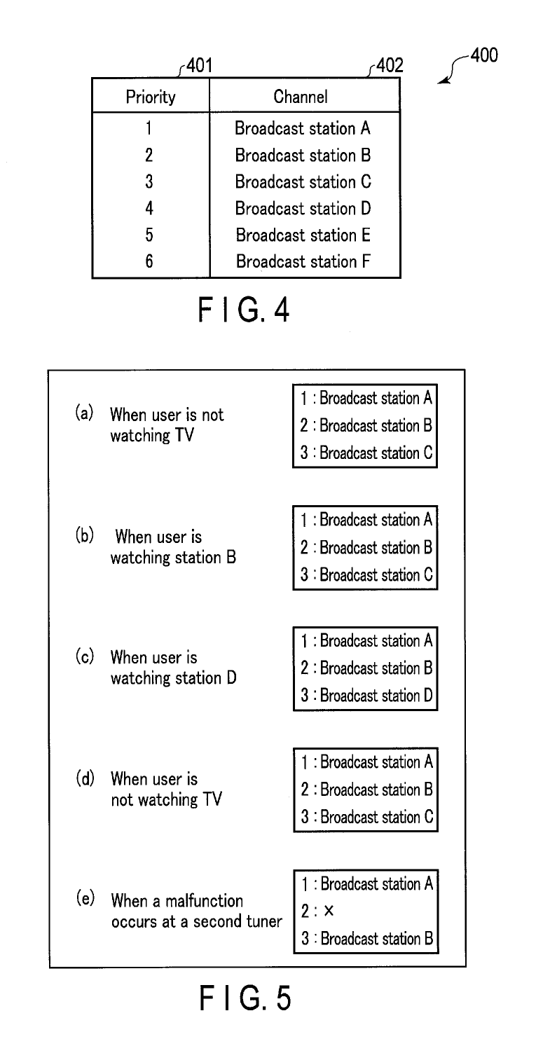

Next, priority of video contents displayed on the image receiving apparatus is described with reference to FIG. 4.

As shown in a table 400 in FIG. 4, the priority 401 and the channel 402 are paired. F or example, the table 400 stores a pair of the priority 401 “1” and the channel 402 “broadcast station A”.

It is desirable that the number of the tuners 201 corresponds to the number of channels viewable in an area where the image receiving apparatus 101 is located. If the number of the tuners 201 is less than the number of channels, the priority of the channels that the user wants to record should be determined and stored in advance, as shown in the table of FIG. 4.

Moreover, when there is a tuner which cannot temporarily decrypt a broadcast wave due to a malfunction, for example, it is possible to select which channel should be allocated to another tuner with a higher priority, referring to the priority 401.

Next, an example of selecting a broadcast station when there are three tuners referring to the priority is described with reference to FIG. 5.

FIG. 5 (a) shows a case where a user is not watching a video content on the image receiving apparatus 101. In this case, the decoding process is performed on the broadcast waves of the top three most prioritized broadcast stations (channels) according to the priority 401 shown in the table of FIG. 4. FIG. 5 (b) shows a case where a user is watching the video content currently being broadcast on the image receiving apparatus 101. If a video content that the user wants to watch is allocated to a tuner, the video content can be played. FIG. 5 (c) shows a case where a user wants to watch the video content to which a tuner is not allocated. In this case, the video content that the user wants to watch is decoded instead of a video content allocated to the tuner 201 and with the lowest priority. For example, the broadcast wave of the broadcast station D is allocated to the tuner, instead of the broadcast wave of the broadcast station C, and is decoded.

As shown in FIG. 5 (d), when a user is not watching the image receiving apparatus 101, the decoding process should be performed based on the priority 401. As shown in FIG. 5 (e), when one of the tuners cannot be used due to a malfunction, the broadcast waves are decoded in the descending order of the priority. For example, if the tuner originally allocated to the broadcast station B which is second in priority is having a malfunction, the tuner allocated to the broadcast station C which is third in priority is allocated to the broadcast station B to decode the broadcast wave of the broadcast station B.

Next, an example of the verification process at the image receiving apparatus 101 is described with reference to FIG. 6.

The verification unit 202 can verify whether or not the usage of the video content at a household falls under personal use by determining if the household which actually uses the image receiving apparatus has concluded a contract or not. If the household using the image receiving apparatus has concluded a contract, the verification is deemed to be successful, and it is determined that the usage of the video content falls under personal use.

Since it is possible for one household to purchase more than one image receiving apparatus and set them in different regions across the country, the encryption key generated at the time of concluding the contract may enable a user to watch a program recorded in different regions.

To prevent a user from watching a program broadcast in a different region, biometric information of a user or a location of the image receiving apparatus may be verified.

As a method of verifying user's biometric information, fingerprint verification, vein verification, and iris verification as shown in FIG. 6 or other known biometric verification may be adopted. As a method of verifying a location of the image receiving apparatus, a method of obtaining location information by a global positioning system (GPS) sensor capable of obtaining GPS-based location information, and if the image receiving apparatus can use wireless LAN, such as Wi-Fi® , a method of obtaining location information from a location of a wireless base station, are known. For example, the verification unit 202 can verify a location by matching location information based on a GPS with an address of the household at which a user concluded a contract.

It is desirable to carry out verification as frequently and regularly as possible; on the other hand, it is inconvenient for a user if the service is stopped when the user does not use the image receiving apparatus for a long period of time, such as being away from home due to traveling. Thus, it may be possible to carry out verification when a user operates a remote controller or a panel, or a threshold is exceeded by an acceleration measured by an acceleration sensor built in the image receiving apparatus when the image receiving apparatus is moved.

Data used for verification may be registered in the server 102, not in the image receiving apparatus 101, so that a verification process can be carried out in the verification unit 202 of the server 102.

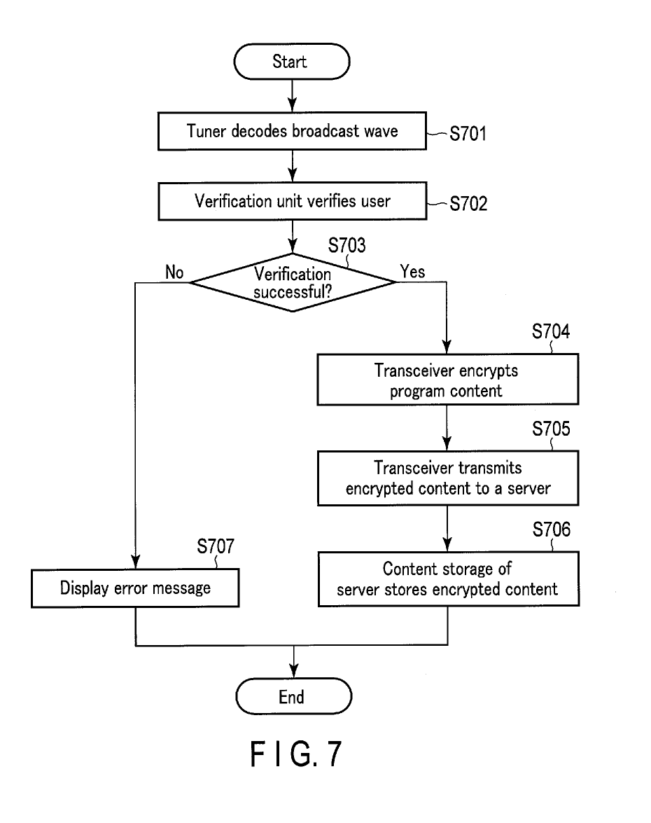

Next, the operation of the cloud TV system according to the first embodiment is described with reference to the flowchart of FIG. 7.

In step S701, the tuner 201 of the image receiving apparatus 101 decodes a broadcast wave.

In step S702, the verification unit 202 of the image receiving apparatus 101 verifies a user.

In step S703, the verification unit 202 of the image receiving apparatus 101 determines whether or not the verification is successful. If the verification is successful, the process proceeds to step S704; if the verification is not successful, the process proceeds to step S707.

In step S704, the transceiver 203 of the image receiving apparatus 101 encrypts the video content. In the encryption process, if a public key encryption scheme is adopted, a secret key is stored in the verification unit 202 in advance, and the encrypted content is transmitted to the server 102 using a public key corresponding to the secret key.

In step S705, the transceiver 203 of the image receiving apparatus 101 transmits the encrypted content to the server 102.

In step S706, the content storage 303 of the server 102 stores the encrypted content.

In step S707, the display 204 of the image receiving apparatus 101 displays an error message. This concludes the operation of the cloud TV system 100 according to the first embodiment.

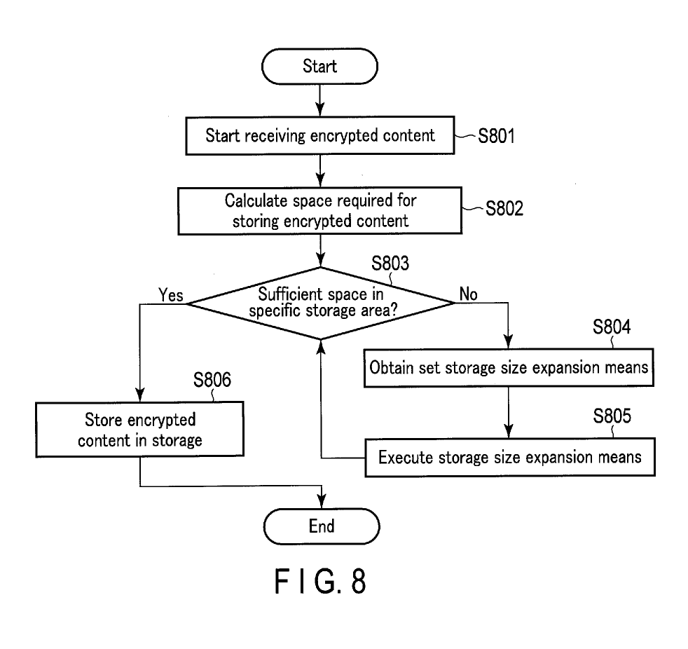

Next, the process of storing the encrypted content at the server 102 in step S706 is described with reference to the flowchart of FIG. 8.

In step 801, the transceiver 301 begins receiving the encrypted content.

In step 802, the storage size determination unit 302 calculates a storage size required for storing the video content.

In step S803, the storage size determination unit 302 determines whether or not there is an empty storage space sufficient for storing the video content in the content storage 303. If there is a sufficient empty storage space, the process proceeds to step S806; if there is no sufficient empty space, the process proceeds to step S804.

In step S804, the execution unit 306 obtains a storage size expansion means from the storage size expansion means DB 305. As an example, the storage size expansion means DB 305 stores information indicating the storage size expansion means 1, the storage size expansion means 2, and the storage size expansion means 3 (see FIG. 3). The storage size expansion means 1 is a process of deleting old video contents; the storage size expansion means 2 is a process of expanding a storage area under contract at additional cost; and the storage size expansion means 3 is a process of re-encoding old video content to lower a bit rate. The execution unit 306 may obtain a storage size expansion means in accordance with a user's designation or a priority set by a user. If the video content designated as a target for the process by the storage size expansion means 1 is protected by a user, the process, such as deleting, is performed on a video content other than the designated video content. Furthermore, if the re-encoding is performed by the storage size expansion means 3, it is expected that decryption cannot be often carried out because there is no decryption key on the server 102 side. Accordingly, it is desirable that the video content targeted for the re-encoding process is first transmitted to the image receiving apparatus 101, and the video content is then transmitted again to the server 102 after the re-encoding.

In step S805, after the execution unit 306 executes the storage size expansion means, the process returns to step S803, and the process is repeated until a sufficient empty storage space for the video content is secured. When the process is repeated, the execution unit 306 may change a storage size expansion means to another storage size expansion means. For example, if the storage size expansion means 1 is selected for the first execution by the execution unit 306, the execution unit 306 may acquire a different storage size expansion means, e.g., the storage size expansion means 2 for the second execution. Furthermore, when a storage size expansion means is executed a second time, the execution unit 306 may change a storage size expansion means to a different storage size expansion means designated by a user, if any. Any storage size expansion means should be executed until a sufficient empty space for storing the video content is secured.

In step S806, the content storage 303 stores the video content. This concludes the process of storing the video content.

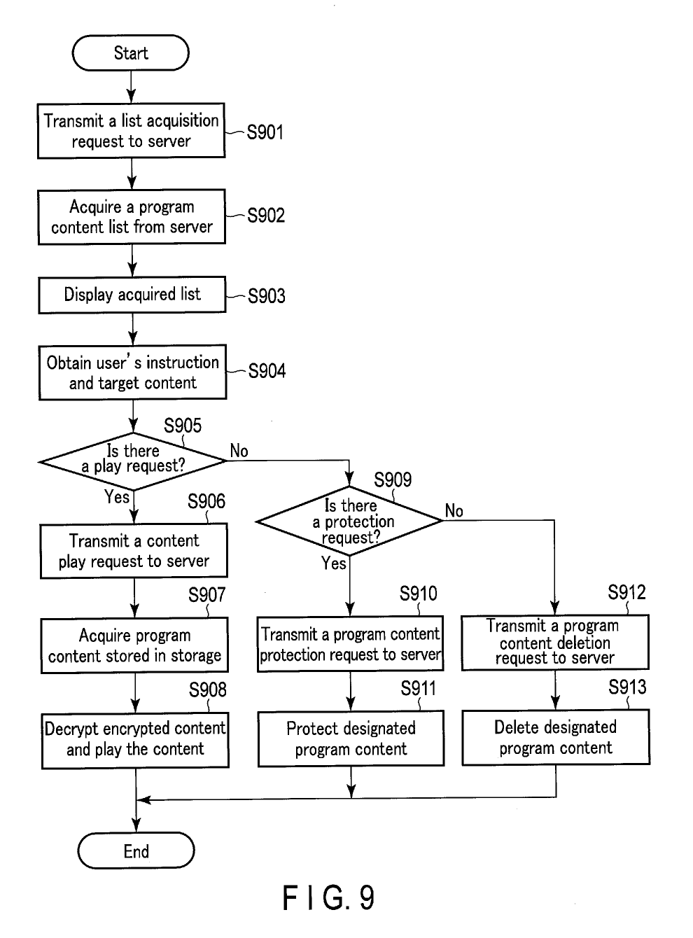

Next, an operation of video content management is described with reference to the flowchart of FIG. 9.

In step S901, the transceiver 203 receives a list acquisition request for requesting a video content list from a user, and transmits the list acquisition request to the server 102 which stores the content video. It is assumed that a decoding process by the image receiving apparatus 101 and a video content recording process are normally carried out in parallel; thus, it is taken for granted that verification of whether or not a household which actually uses the image receiving apparatus 101 has already concluded a contract is presumed to be successful. In the case where a verification process is carried out in response to when a user operates a remote controller or a panel, the verification process may be carried out upon receiving the list acquisition request from a user. If verification is failed in either case, the server 102 stops the list acquisition request.

In step S902, the transceiver 203 acquires the video content list from the server 102.

In step S903, the display 204 displays the acquired video content list. Since it is expected that the data size of the recorded video contents will be enormous, it is desirable to include a user interface (UI) that allows a user to select recorded video contents by groups, not just by an UI that looks similar to a TV program listing. The selection of a group of video contents can be made using an algorithm for scheduling the recording of a series of soap operas or animation programs, etc. using information, such as a day of the week, a time of a day, and a program title, etc. Thus, an explanation of the selection of a group of video contents is omitted.

In step S904, the transceiver 203 obtains a user's instruction and information of a video content which is a target of the instruction, such as an identifier (ID).

In step S905, the transceiver 203 determines whether or not the user's instruction is a play request. If the instruction is a play request, the process proceeds to step S906; if not a play request, the process proceeds to step S907.

In step S906, the transceiver 203 transmits the play request to the server 102.

In step S907, the transceiver 203 obtains from the server 102 the encrypted content corresponding to the play request. Similar to the case where the list acquisition request is sent, verification is presumably successful; however, if verification has failed, the server 102 does not transmit the video content.

In step S908, the transceiver 203 decrypts the encrypted content obtained from the server 102 using the encryption key stored in the verification unit 202, and the transceiver 203 plays the video content.

In step S909, the transceiver 203 determines whether or not the user's instruction is a protection request. The protection request is an instruction to designate an encrypted content so that the encrypted content is not deleted by a storage size expansion means even when there is no space in the specific storage area in the content storage 303. If the user's instruction is a protection request, the process proceeds to step S910; if not a protection request, the process proceeds to step S912.

In step S910, the transceiver 203 transmits the protection request to the server 102. In step S911, the execution unit 306 of the server 102 protects the video content. Specifically, a process of raising a protection bit of management information of the video content to be protected should be carried out, for example.

In step S912, the transceiver 203 transmits a request for deleting a video content to the server 102. The deletion request is an instruction to delete the video content designated by a user.

In step S913, the execution unit 306 of the server 102 deletes the video content. This concludes the operation of video content management.

There may be a possibility that a video content has been already deleted when the server receives a play request, a protection request, or a deletion request, even if the video content which is designated in any of those requests existed in the content storage 303 at the time when the server acquired the list acquisition list. Thus, except for the video content for which a protection bit is raised, a video content which is highly likely to be deleted by a storage size expansion means may be shown as translucent in the list, or may not be shown in the list at all.

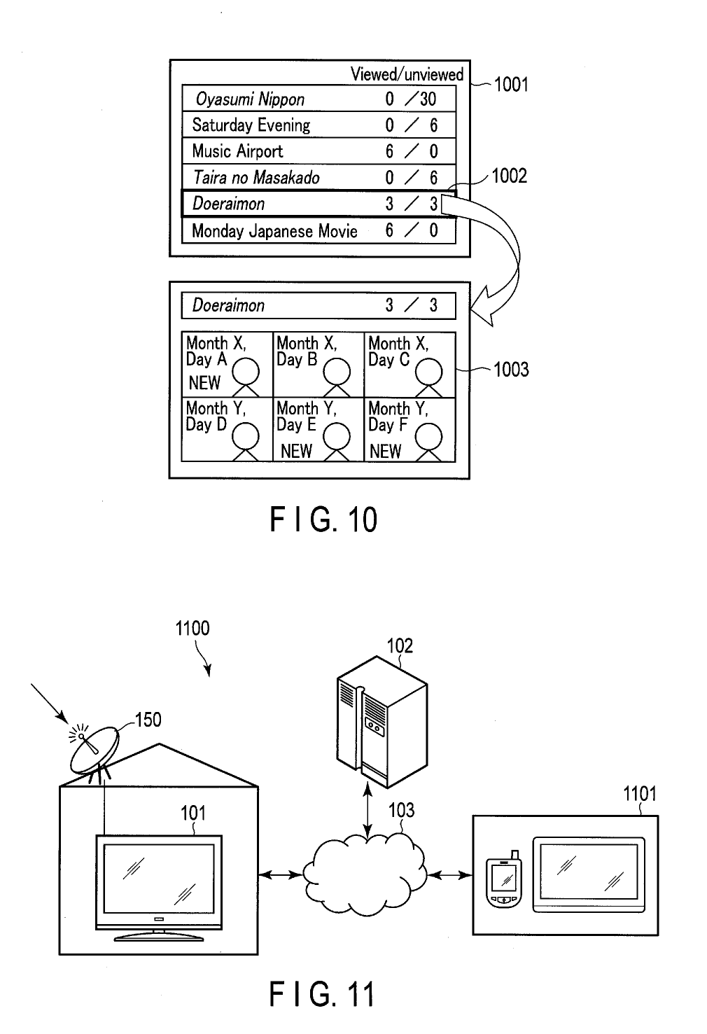

Next, an example of a display of a list of video contents on the image receiving apparatus is described with reference to FIG. 10.

The top list in FIG. 10 is an example of a list 1001 of video contents grouped by program titles, and the bottom list is an example of a video content selected from the list.

The list shows how many video contents have or have not been viewed. For example, for the program title “Doeraimon”, three video contents have been viewed, three have not been viewed, and a total of six video contents are recorded.

If the program title “Doeraimon” in the list is selected by a cursor 1002, a thumbnail 1003 of each of the six recorded video contents is displayed as shown in the bottom list in FIG. 10, and if a video content has not been viewed, the label “NEW” is indicated. The thumbnail is not limited to a still image; the thumbnail may show a frame-advance, or a moving image. The video contents that have not been viewed can be distinguished by flashing.

According to the above-described first embodiment, recorded video contents can be stored for a long period of time, without taking the storage capacity of a server (storage) for storing recorded video contents into consideration. Furthermore, it is possible to record a video content within the range of personal use, and for a user to watch the video content when they want to.

### Second Embodiment

The second embodiment is different from the first embodiment in terms of the use of a mobile terminal, such as a smart phone and a tablet personal computer (PC), for playing the video content recorded on a server, in addition to an image receiving apparatus, such as a TV.

A cloud TV system according to a second embodiment is described with reference to FIG. 11.

FIG. 11 is a conceptual drawing of a cloud TV system 1100 according to the first embodiment. A cloud TV system 1100 includes an image receiving apparatus 101, a server 102, a network 103, and a mobile terminal 1101.

The operation of each of image receiving apparatus 101, the server 102, and the network 103 is the same as that in the first embodiment; accordingly, the explanation of the operation is omitted.

The mobile terminal 1101 is a smart phone or a tablet PC, for example, and receives the recorded video content from the image receiving apparatus 101 via the network 103, and plays it.

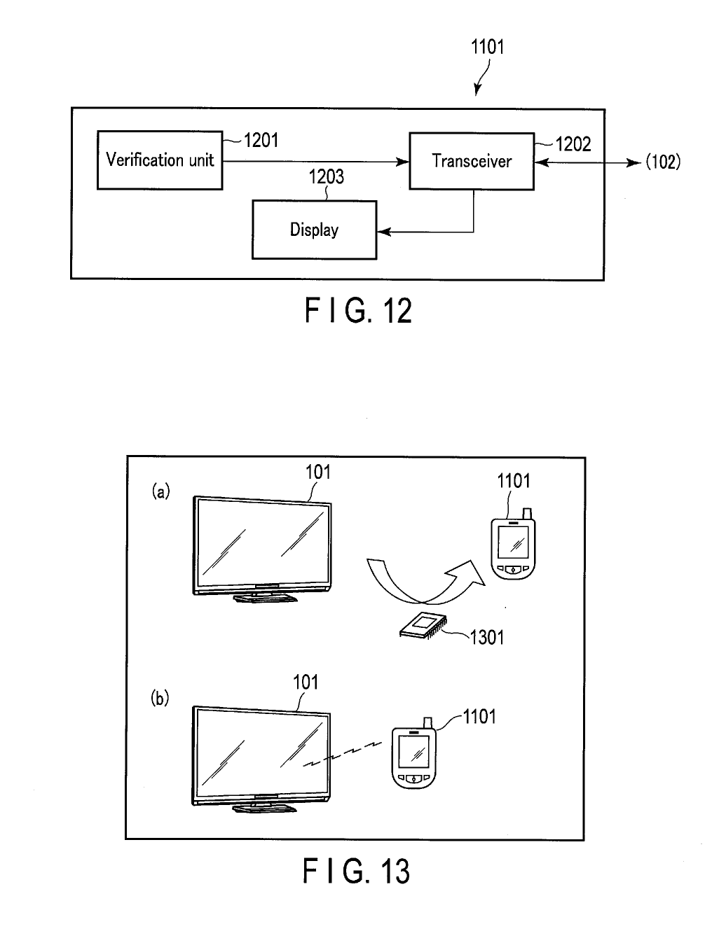

Next, the mobile terminal 1101 is described with reference to the block diagram of FIG. 12.

The mobile terminal 1101 includes a verification unit 1201, a transceiver 1202, and a display 1203.

The verification unit 1201 carries out verification similar to the verification unit 202 of the image receiving apparatus according to the first embodiment.

If the verification is successful and the transceiver 1202 receives a list acquisition request from a user, the transceiver 1202 transmits the list acquisition request to the server 102. Subsequently, the transceiver 1202 receives a list of recorded video contents from the server 102. If the transceiver 1202 receives a play request from a user, the transceiver 203 transmits the play request to the server 102, and receives an encrypted content selected by the user from the server 102. The transceiver 1202 receives a verification key and an encryption key from the verification unit 1201, and decrypts the encrypted content to obtain the video content.

The display 1203 receives the video content list from the transceiver 1202, and displays it. Furthermore, the display 1203 receives and displays the video content selected by a user.

Next, an example of a verification process at the mobile terminal 1101 is described with reference to FIG. 13.

In a verification process, as shown in FIG. 13 (a), for example, a chip 1301, etc. for storing the encryption key stored in the image receiving apparatus 101 in advance is physically moved to the mobile terminal 1101 which is a target for the verification process. As shown in FIG. 13 (b), the encryption key may be copied by a short range wireless communication or a physical contact. Furthermore, in the mobile terminal 1101, a verification process can be deemed to be completed, without any verification process carried out by the mobile terminal 1101, by receiving a verification key indicating that verification of the image receiving apparatus 101 is successful. However, such an encryption key is configured to be deleted after a certain period of time has elapsed for security reasons.

For verification, it is desirable to combine a user's biometric information and location information obtained by a GPS sensor included in the mobile terminal. The reason for this is, in a case of just copying the encryption key, not physically moving the IC chip itself, it will become possible to watch a video content in a region different from the region where the video content was broadcast if a plurality of mobile terminals purchased by a single household are set across the country.

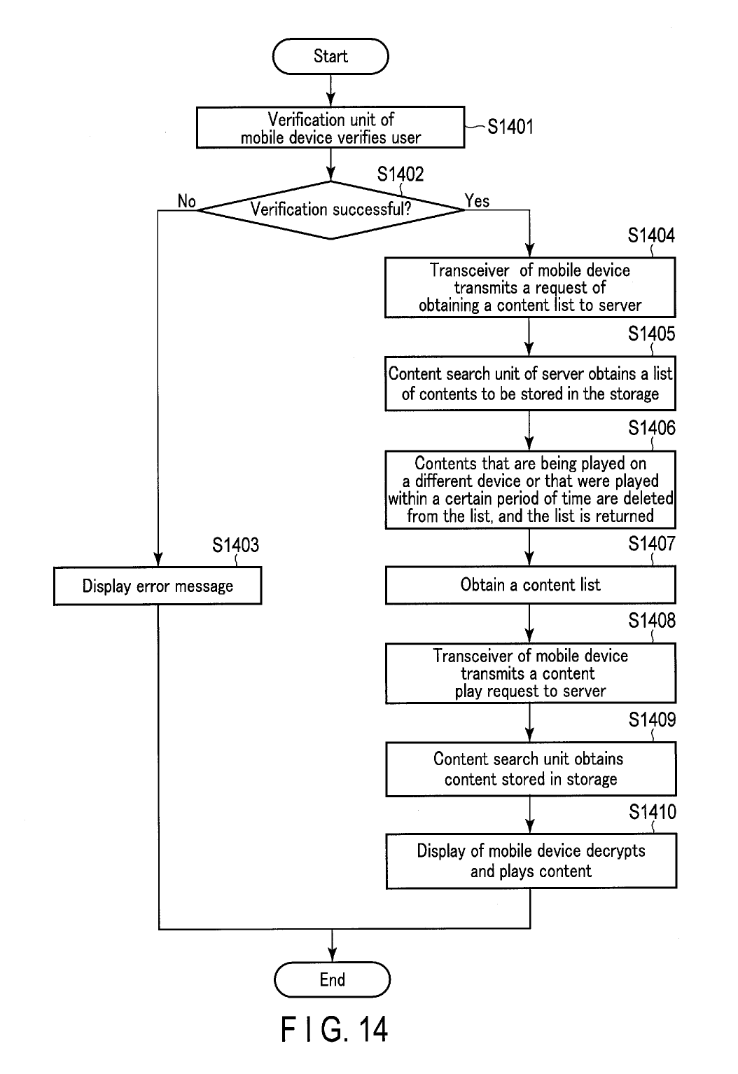

Next, an operation of the cloud TV system according to the second embodiment will be described with reference to the flowchart of FIG. 14.

In step S1401, the verification unit 1201 of the mobile terminal 1101 verifies a user.

In step S1402, the verification unit 1201 of the mobile terminal 1101 determines whether or not the verification is successful. If the verification is successful, the process proceeds to step S1404; if the verification is not successful, the process proceeds to step S1403.

In step S1403, the display 1203 of the mobile terminal 1101 displays an error message, and the process is completed.

In step S1404, the transceiver 1202 of the mobile terminal 1101 transmits a request of acquiring a list of video contents to the server 102.

In step S1405, the content storage 304 of the server 102 generates a list of video contents stored in the content storage 303.

In step S1406, the content search unit 304 of the server 102 generates a list of video contents except for the video content that is being played or that was played a predetermined length of time ago on an image receiving apparatus or device different from the one which is being used by a user, and returns the list to the mobile terminal 1101. Thus, it is possible to avoid double-transmission of the same video content to more than one device.

In step S1407, the transceiver 1202 of the mobile terminal 1101 obtains the video content list.

In step S1408, the transceiver 1202 of the mobile terminal 1101 transmits a play request for a video content selected by a user to the server 102.

In step S1409, the content search unit 304 of the server 102 obtains an encrypted content designated by a user which is stored in the content storage of the server 102 based on the play request.

In step S1410 the transceiver 1202 of the mobile terminal 1101 decrypts the encrypted content using the encryption key stored in the verification unit 1201, and the display 1203 plays and displays the video content. This concludes the operation of the cloud TV system 1100 according to the second embodiment.

According to the above second embodiment, it is possible to play a recorded video on an easy-to-carry mobile terminal; thus, a user can watch a video regardless of where the video content is stored or where the user is located, and a user can store (record) the video content without concern regarding storage capacity within the range of personal use.

The instructions indicated in the operation procedure of the above-described embodiment can be carried out based on a software program. It is possible to configure a general-purpose calculating system to store this program in advance and to read a program in order to achieve the same advantageous effects as those achieved by the above-described image receiving apparatus, mobile terminal, and server. The instructions described in the above embodiments are written in a magnetic disc (flexible disc, hard disc, etc.), an optical disc (CD-ROM, CD-R, CD-RW, DVD-ROM, DV±R, DVD±RW, Blu-ray® disc, etc.) a semiconductor memory, or similar storage medium, as a program executable by a computer. As long as a storage medium is readable by a computer or a built-in system, any storage type can be adopted. An operation similar to the operation of the image receiving apparatus, mobile terminal, and server of the above-described embodiments can be realized if a computer reads a program from the storage medium, and executes the instructions written in the program on the CPU based on the program. A program can be obtained or read by a computer through a network, of course.

Furthermore, an operating system (OS) working on a computer, database management software, middleware (MW) of a network, etc. may execute a part of processes for realizing the present embodiments based on instructions from a program installed from a storage medium onto a computer and a built-in system.

Furthermore, the storage medium according to the present embodiments is not limited to a medium independent from a system or a built-in system; a storage medium storing or temporarily storing a program downloaded through LAN or the

Internet, etc. is also included as the storage medium according to the present embodiments.

Furthermore, a storage medium is not limited to one; when the process according to the present embodiments is carried out in multiple storage media, these storage media are included as a storage medium according to the present embodiments, and can take any configuration.

The computer or built-in system in the present embodiments are used to execute each process disclosed in the present embodiments based on a program stored in a storage medium, and the computer or built-in system may be an apparatus consisting of a PC or a microcomputer, etc. or a system, etc. in which a plurality of apparatuses are connected through network.

The computer adopted in the present embodiments is not limited to a PC; it may be a calculation processing apparatus, a microcomputer, etc. included in an information processor, and a device and apparatus that can realize the functions disclosed in the present embodiments by a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image receiving apparatus, comprising:
a tuner which decodes a broadcast wave into a video content;
a verification unit which performs a verification that determines whether or not a use of the decoded video content falls under a personal use;
a transceiver which encrypts and transmits the video content to a server when the verification is successful, and which transmits to the server an acquisition request and receives the list when the acquisition request is received from a user, the acquisition request being a request for obtaining a list of a plurality of video contents stored in the server; and
a display which displays the list and the video content, wherein
the transceiver receives from the user a play request for designating a first video content to play from the video contents included in the list, transmits the play request to the server to receive the first video content which is encrypted, and decrypts the first video content which is encrypted, and
the display displays the decrypted first video content.

2. The apparatus according to claim 1, wherein when a user's operation is performed by using a remote controller or a panel, the verification unit carries out the verification using biometric information of the user.

3. The apparatus according to claim 1, further comprising a global positioning system (GPS) sensor which obtains GPS-based location information, wherein
the verification unit carries out the verification using the location information and an address of a household at which the user is contracted a contract.

4. The apparatus according to claim 1, wherein the verification unit updates a verification key on a regular basis.

5. A mobile terminal, comprising:
a mobile verification unit which performs another verification that determines whether or not a use of a video content falls under a personal use, using a verification key obtained from the verification unit of claim 1;
a mobile transceiver which transmits the acquisition request to the server when the another verification is successful and when the acquisition request is received from the user; and
a mobile display which displays the list and the video content, wherein
if the mobile transceiver receives from the user the play request, the transceiver transmits the play request to the server to receive the first video content which is encrypted, and decrypts the first video content which is encrypted, and
the display displays the decrypted first video content.

6. The terminal according to claim 5, wherein when a user's operation is performed by using a remote controller or a panel, the mobile verification unit carries out the another verification using biometric information of the user.

7. The terminal according to claim 5, further comprising a global positioning system (GPS) sensor which obtains GPS-based location information, wherein
the mobile verification unit carries out the another verification using the location information and an address of a household at which the user is contracted a contract.

8. The terminal according to claim 5, wherein the mobile verification unit deletes the verification key after a first period has elapsed.

9. A server, comprising:
a verification unit which performs a verification that determines whether or not a use of a video content falls under a personal use;
a transceiver which receives the video content when the verification is successful;
a storage which stores, in a specific storage area, the video content transmitted from a user of an image receiving apparatus, the specific storage area being uniquely paired with the user; and
a search unit which generates a list of a plurality of stored video contents when an acquisition request for obtaining the list is received, wherein
the transceiver transmits a first video content among the stored video contents when a play request for the first video content is received.

10. The server according to claim 9, further comprising:
a storage size determination unit which determines whether or not a space for storing the video content is secured in the specific storage area, and which, if no space is secured, generates space shortage information indicating a space required for storing the video content; and
an execution unit which executes a storage size expansion means for securing the space in the storage based on the space shortage information.

11. The server according to claim 9, wherein when the acquisition request is received, the search unit generates the list of video contents, except for one or more second video content which are playing on another device and one or more third video content which were played on another device within a second period.

12. The image receiving method, comprising:
decoding a broadcast wave into a video content;
performing a verification that determines whether or not a use of the decoded video content falls under a personal use;
encrypting and transmitting the video content to a server when the verification is successful, and which transmitting to the server an acquisition request and receiving the list when the acquisition request is received from a user, the acquisition request being a request for obtaining a list of a plurality of video contents stored in the server;
displaying the list and the video content;
receiving from the user a play request for designating a first video content to play from the video contents included in the list, transmitting the play request to the server to receive the first video content which is encrypted, and decrypting the first video content which is encrypted; and
displaying the decrypted first video content.

13. The method according to claim 12, wherein when a user's operation is performed by using a remote controller or a panel, the performing the verification carries out the verification using biometric information of the user.

14. The method according to claim 12, further comprising obtaining global positioning system (GPS)-based location information, wherein
the performing the verification carries out the verification using the location information and an address of a household at which the user is contracted a contract.

15. The method according to claim 12, wherein the performing the verification updates a verification key on a regular basis.

16. A storing method, comprising:
performing a verification that determines whether or not a use of a video content falls under a personal use;
receiving the video content when the verification is successful;
storing, in a specific storage area, the video content transmitted from a user of an image receiving apparatus, the specific storage area being uniquely paired with the user;
generating a list of a plurality of stored video contents when an acquisition request for obtaining the list is received; and
transmitting a first video content among the stored video contents when a play request for the first video content is received.

17. The method according to claim 16, further comprising:
determining whether or not a space for storing the video content is secured in the specific storage area, and if no space is secured, generating space shortage information indicating a space required for storing the video content; and
executing a storage size expansion means for securing the space in the storage based on the space shortage information.

18. The method according to claim 16, wherein when the acquisition request is received, the generating generates the list of video contents, except for one or more second video content which are playing on another device and one or more third video content which were played on another device within a second period.
